(19) United States
(12) Patent Application Publication
(10) Pub. No.: US 2013/0060865 A1
(43) Pub. Date: Mar. 7, 2013

(54) SYNCHRONIZATION OPERATION BASED ON A FILTER TAG

(71) Applicant: Narasimha REDDY K V, Hyderabad (IN)

(72) Inventor: Narasimha REDDY K V, Hyderabad (IN)

(21) Appl. No.: 13/226,331

(22) Filed: Sep. 6, 2011

(51) Int. Cl. G06F 15/16

(52) U.S. Cl. 709/206

(57) ABSTRACT

A method performed by a processing system includes receiving a synchronization command that includes a filter tag as a parameter from a user device of a user and providing only a set of items for the user that include the filter tag to the user device.

### BACKGROUND

Electronic mail (email) has become a widely used form of communications for users of electronic devices. These users of electronic devices often purchase data or network service plans that allow the devices to communicate with other devices over a communication network. These service plans may have fees that are based on the amount of data sent or received by a user with the electronic device. Some users receive a large number of emails that result in a large amount of data being received by a user's electronic device. As a result, email may increase the fees that users pay for service plans.

### BRIEF DESCRIPTION OF THE DRAWINGS

FIG. 1 is a block diagram illustrating one embodiment of an email environment that implements a synchronization operation based on a filter tag.

FIG. 2 is a schematic diagram illustrating one embodiment of a synchronization operation based on a filter tag.

FIG. 3 is a flow chart illustrating one embodiment of a method for performing a synchronization operation based on a filter tag in a user device.

FIGS. 4A-4B are schematic diagrams illustrating embodiments of a user interface displayed by a user device.

FIG. 5 is a flow chart illustrating one embodiment of a method for performing a synchronization operation based on a filter tag in an email server.

FIG. 6 is a block diagram illustrating one embodiment of identifying a set of items with a filter tag.

FIG. 7 is a block diagram of a processing system that forms a user device or an email server.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a synchronization operation based on a filter tag, such as an email subject, is provided. The synchronization operation allows a user of a mobile device to input a filter tag to cause only those items (e.g., emails) that include the designated filter tag to be received by the user device. By doing so, the user can prevent items that do not include the designated filter tag from being downloaded from an email server to the user device. As a result, the user can reduce the amount of items that are viewed on the user device to save time and any data transfer costs associated with a data or network service plan that the user may have for the user device.

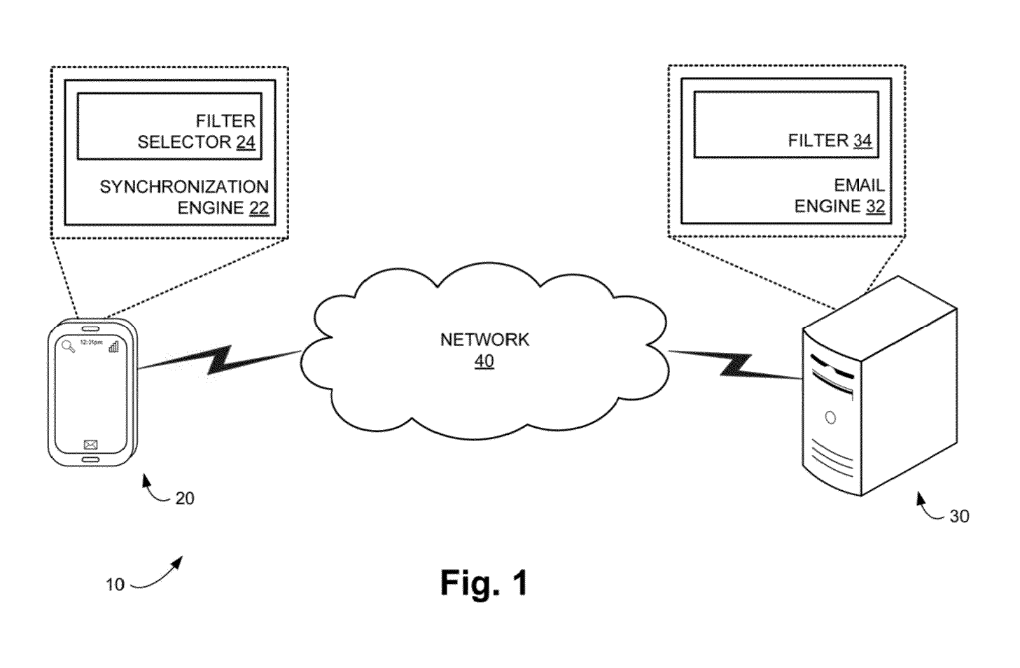

FIG. 1 is a block diagram illustrating one embodiment of an email environment 10 that implements a synchronization operation based on a filter tag. Environment 10 includes a user device 20 that communicates with an email server 30 using a communications network 40.

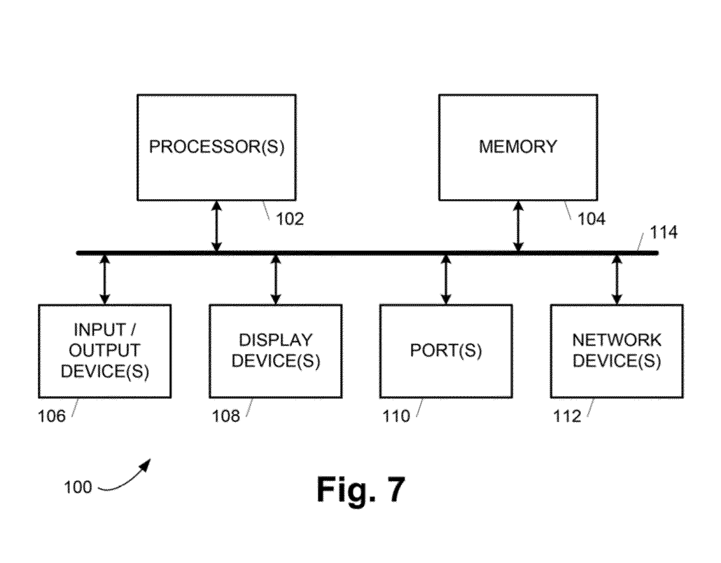

User device 20 represents a processing system, such as a processing system 100 shown in FIG. 7 and described in additional detail below, that includes an email program (not shown) and a synchronization engine 22 in addition to other features that user device 20 may provide. User device 20, in some embodiments, represents a mobile telephone or a tablet computer system. The email program allows a user to send and receive emails and may also provide additional email processing capabilities such as searching, sorting, and printing emails. The email program generally allows a user to send an email (i.e., an outgoing email) by entering a recipient address or addresses for a recipient user or users, a subject, and some form of textual, graphical, and/or multimedia communication. The email program provides outgoing emails to email server 30 for distribution to the recipient users. The email program also generally allows a user to receives email from other users (i.e., incoming email) who specify a recipient address of the user. The received emails may include a subject, some form of textual, graphical, and/or multimedia communication, and a list of other recipients of an email. The email program accesses incoming email from server 30 and displays the incoming email to the user of user device 20. The email program may also include contacts, calendar events, and tasks features.

Synchronization engine 22 is configured to perform synchronization operations to update the state of the user's email environment on user device 20 with the state stored on email server 30. The email environment includes the user's email and, where included, the user's contacts, calendar events, and tasks. In particular, synchronization engine 22 provides commands to server 30 that cause server 30 to provide all incoming items (i.e., emails, contacts, calendar events, and tasks) or, using filter selector 24, selected incoming items and other synchronization information to the email program on user device 20. Synchronization engine 22 includes filter selector 24. Filter selector 24 provides the user with the ability to enter filter tags that correspond to the set of items on email server 30 the user wishes to download to user device 20. A filter tag may be an email subject, an email identifier (id), an email flag, a name, a subject, a keyword, or another suitable criteria that may be entered by the user. Filter selector 24 causes the filter tag to be added as a parameter to a synchronization command provided by synchronization engine 22 to email server 30.

Email server 30 represents a processing system, such as processing system 100 shown in FIG. 7 and described in additional detail below, that includes an email engine 32 in addition to other features that email server 30 may provide. Email engine 32 manages the email accounts of users including the user of user device 20. Email engine 32 receives emails intended for the user of user device 20 and stores the emails until retrieved by user device 20. Email engine 32 also receives emails from the user of user device 20 and distributes those emails to other users (not shown) by providing the emails directly to user devices of the users (not shown) or to other email servers (not shown) that manage the email accounts of the other users using either network 40 or another suitable communications network (not shown). In addition to emails, email engine 32 may manage other items of users including contacts, calendar entries, and tasks.

Email engine 32 receives synchronization commands from user device 20 and provides items and other information to user device 20 in accordance with the command. For synchronization commands that include a parameter that specifies a filter tag, a filter 34 in email engine 32 processes the filter tag to identify a set of items for the user of user device 20 that include the filter tag. Email engine 32 provides only the set of items (i.e., emails, contacts, calendar entries, and/or tasks) that include the filter tag to user device 20 in response to receiving a synchronization command that includes a filter tag parameter. Email engine 32 prevents other items that do not include the filter tag from being provided to user device 20 where a synchronization command with a filter tag parameter is processed. For synchronization commands without a filter tag parameter, email engine 32 may provide all items for the user to user device 20.

Communications network 40 represents any suitable type, combination and/or configuration of wired and/or wireless networking devices that allow for communication between user device 20 and email server 30. For example, network 40 may represent a mobile telecommunications network and/or the Internet in some embodiments.

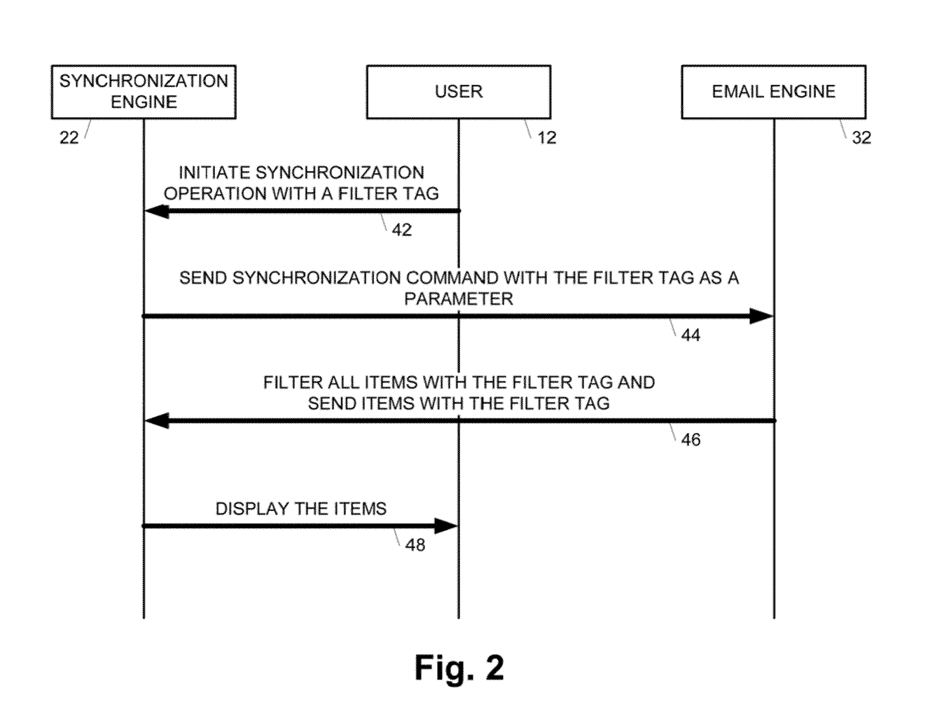

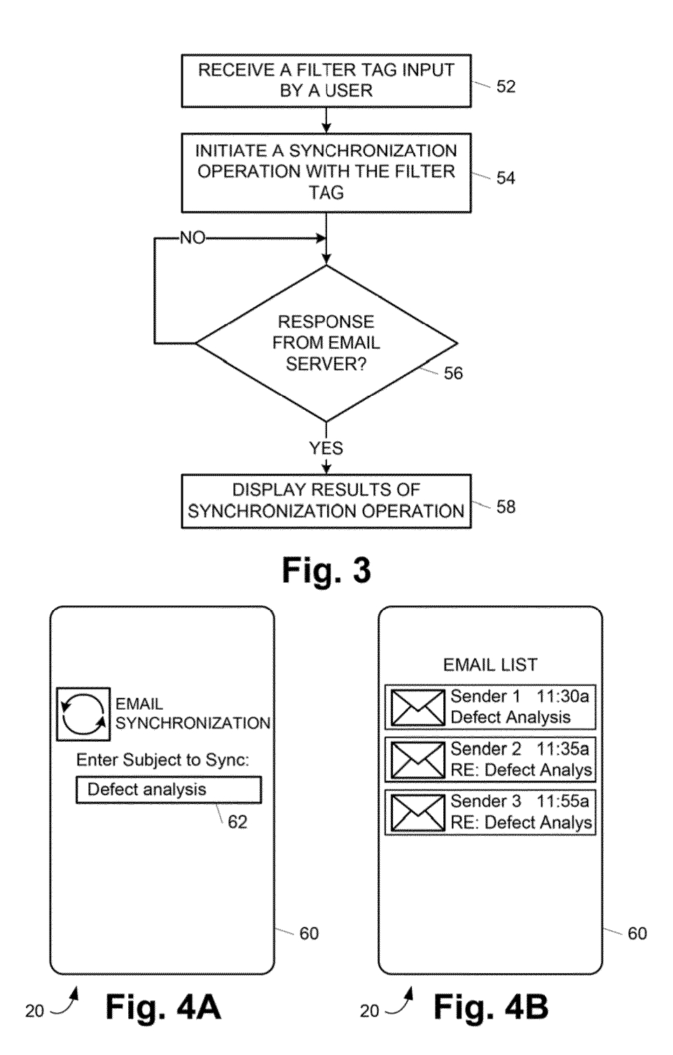

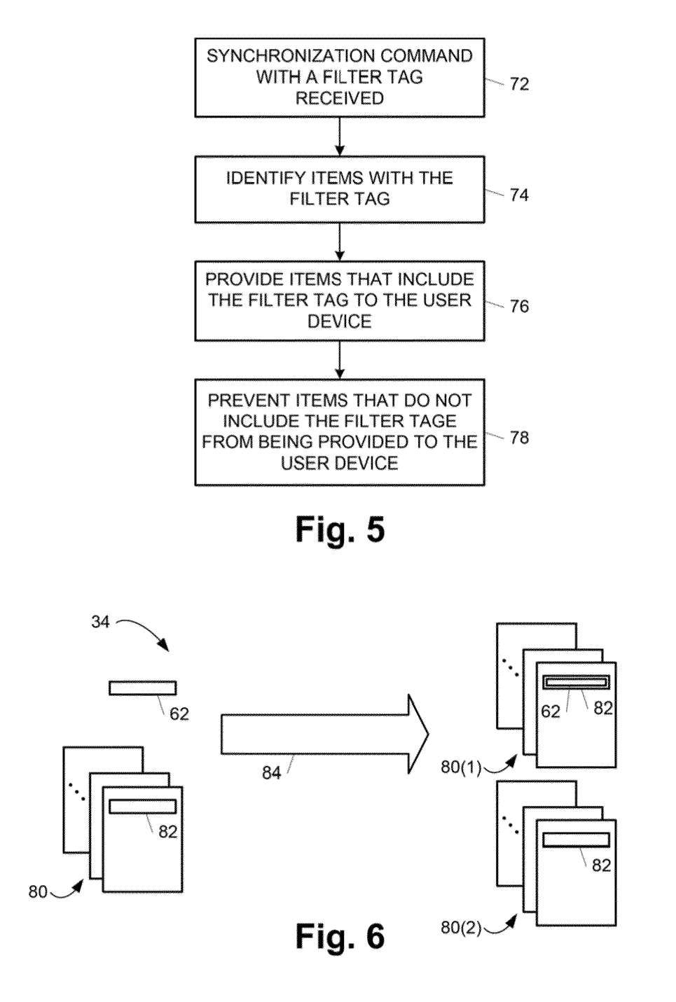

Additional details of a synchronization operation based on a filter tag will now be described with reference to FIG. 2, which is a schematic diagram illustrating one embodiment of a synchronization operation based on a filter tag. The embodiment of FIG. 2 will be described with reference to FIGS. 3-6. FIG. 3 is a flow chart illustrating one embodiment of a method for performing a synchronization operation based on a filter tag in a user device 20. FIGS. 4A-4B are schematic diagrams illustrating embodiments of a user interface 60 displayed by user device 20. FIG. 5 is a flow chart illustrating one embodiment of a method for performing a synchronization operation based on a filter tag in email server 30. FIG. 6 is a block diagram illustrating one embodiment of identifying a set of items with a filter tag in email server 30.

As shown in FIG. 2, a user 12 of user device 20 may initiate a synchronization operation with a filter tag as indicated by an arrow 42. Synchronization engine 22 receives the filter tag input by the user as indicated in a block 52 in FIG. 3. To allow the email subject to be input, filter selector 24 may cause user interface 60 to be displayed in user device 20 so that the user can enter a filter tag, such as an email subject 62, as shown in FIG. 4A.

After the user enters the filter tag and initiates the synchronization operation, synchronization engine 22 sends a synchronization command with the filter tag as a parameter to email server 30 using communications network 40 as indicated by an arrow 44 in FIG. 2 and a block 54 in FIG. 3. User device 20 waits for a response from email server 30 as indicated in a block 56 in FIG. 3.

Referring to FIGS. 2 and 5, email engine 32 on email server 30 receives the synchronization command with the filter tag as the parameter as indicated by arrow 44 and a block 72. In response to receiving the synchronization command and the parameter, filter 34 identifies items for the user with the filter tag as indicated in a block 74 in FIG. 5. As shown in FIG. 6, filter 34 compares email subject 62 (also shown in FIG. 4A) to a subject 82 of each email in a set of emails 80. From this comparison, filter 34 identifies a subset of emails 80(1) with email subjects 82 that include email subject 62 and a subset of emails 80(2) with email subjects 82 that do not include email subject 62.

Again referring to FIGS. 2 and 5, email engine 32 provides the items that include the filter tag to user device 20 as indicated by an arrow 46 and a block 76 as part of the synchronization operation for the synchronization command with the filter tag parameter. In addition, email engine 32 prevents items that do not include the filter tag from being provided to user device 20 as indicated in a block 78.

In the example of FIGS. 4A, 4B, and 6, email engine 32 only sends the subset of emails 80(1) that include email subject 62 to user device 20 as part of the synchronization operation for the synchronization command with the filter tag parameter. In addition, email engine 32 prevents the subset of emails 80(2) that do not include the email subject from being provided to user device 20.

Referring back to FIG. 3, synchronization engine 22 receives the items that include the filter tag from email engine 32 as part of the response from email server 30 in block 56. Synchronization engine 22 displays the results of the synchronization operation as indicated in a block 58. If at least one item is received, then synchronization engine 22 may cause some or all of the items to be displayed. If no items with the filter tag were found by filter 34, then synchronization engine 22 may cause a suitable notice to that effect to be displayed.

In the example of FIGS. 4A, 4B, and 6, synchronization engine 22 receives the subset of emails 80(1) that include email subject 62 from email engine 32 as part of the response from email server 30. Synchronization engine 22 displays the results of the synchronization operation. If the subset of emails 80(1) includes at least one email, then synchronization engine 22 may cause some or all of the emails in subset 80(1) to be displayed in user interface 60 as shown in FIG. 4B. If the subset of emails 80(1) was empty (i.e., no emails with email subject 62 were found by filter 34), then synchronization engine 22 may cause a suitable notice to that effect to be displayed in user interface 60 (not shown).

The above embodiments may advantageously allow the user of user device 20 to save time by accessing only desired items rather than downloading all items to user device 20. By doing so, the user may avoid waiting for all items to download and avoid searching for desired items after the items have downloaded. In addition, the user may save data transfer charges that may accrue in data or network service plans based on the amount of data transferred. By not downloading items that do not include the designated filter tag, the user may reduce the amount of data transferred to user device 20.

In one embodiment, email engine 32 may be implemented with Exchange and synchronization engine 22 may be implemented as part of an Exchange ActiveSync client. Exchange and Exchange ActiveSync are available from Microsoft Corporation. In this embodiment, a user can configure his or her corporate email account or personal email account in user device 20 using Exchange ActiveSync. The user can initiate a synchronization command in Exchange ActiveSync to synchronize emails, contacts, calendar events, and tasks from his or her configured corporate or personal email account to user device 20. Filter selector 24 appends a filter tag as a parameter to the synchronization command of Exchange ActiveSync in this embodiment as described above, and filter 34 filters items using the filter tag in this embodiment as described above. In other embodiments, email engine 32 and synchronization engine 22 may be implemented with other suitable software programs.

FIG. 7 is a block diagram of a processing system 100. As noted above, user device 20 and email server may be implemented as separate processing systems 100 (i.e., a first processing system 100 implements user device 20 and a second processing system 100 implements email server 30).

Processing system 100 includes at least one processor 102 configured to execute machine readable instructions stored in a memory system 104. Processing system 100 may also include any suitable number of input/output devices 106, display devices 108, ports 110, and/or network devices 112. Processors 102, memory system 104, input/output devices 106, display devices 108, ports 110, and network devices 112 communicate using a set of interconnections 114 that includes any suitable type, number, and/or configuration of controllers, buses, interfaces, and/or other wired or wireless connections. Components of processing system 100 (for example, processors 102, memory system 104, input/output devices 106, display devices 108, ports 110, network devices 112, and interconnections 112) may be contained in a common housing (not shown) or in any suitable number of separate housings (not shown).

Processing system 100 may execute a basic input output system (BIOS), firmware, an operating system, a runtime execution environment, and/or other services and/or applications stored in memory 104 (not shown) that includes machine readable instructions that are executable by processors 102 to manage the components of processing system 100 and provide a set of functions that allow other programs (e.g., synchronization engine 22 for user device 20 and email engine 32 for email server 30) to access and use the components.

Processing system 100 represents any suitable processing device, or portion of a processing device, configured to implement the functions of user device 20 or email server 30 as described above. A processing device may be a mobile telephone with processing capabilities (i.e., a smart phone), a digital still and/or video camera, a personal digital assistant (PDA), an audio/video device, or another suitable type of electronic device with processing capabilities. Processing capabilities refer to the ability of a device to execute instructions stored in a memory 104 with at least one processor 102. A processing device may also be a laptop computer, a tablet computer, a desktop computer, a server, or another suitable type of computer system.

Each processor 102 is configured to access and execute instructions stored in memory system 104. Each processor 102 may execute the instructions in conjunction with or in response to information received from input/output devices 106, display devices 108, ports 110, and/or network devices 112. Each processor 102 is also configured to access and store data in memory system 104.

Memory system 104 includes any suitable type, number, and configuration of volatile or non-volatile storage devices configured to store instructions and data. The storage devices of memory system 104 represent computer readable storage media that store computer-readable and computer-executable instructions including synchronization engine 22 for a processing system 100 that implements user device 20 and email engine 32 for a processing system 100 that implements email server 30. Memory system 104 stores instructions and data received from processors 102, input/output devices 106, display devices 108, ports 110, and network devices 112. Memory system 104 provides stored instructions and data to processors 102, input/output devices 106, display devices 108, ports 110, and network devices 112. Examples of storage devices in memory system 104 include hard disk drives, random access memory (RAM), read only memory (ROM), flash memory drives and cards, and other suitable types of magnetic and/or optical disks.

Input/output devices 106 include any suitable type, number, and configuration of input/output devices configured to input instructions and/or data from a user to processing system 100 and output instructions and/or data from processing system 100 to the user. Examples of input/output devices 106 include a touchscreen, buttons, dials, knobs, switches, a keyboard, a mouse, and a touchpad.

Display devices 108 include any suitable type, number, and configuration of display devices configured to output image, textual, and/or graphical information to a user of processing system 100. Examples of display devices 108 include a display screen, a monitor, and a projector. Ports 110 include suitable type, number, and configuration of ports configured to input instructions and/or data from another device (not shown) to processing system 100 and output instructions and/or data from processing system 100 to another device.

Network devices 112 include any suitable type, number, and/or configuration of network devices configured to allow processing system 100 to communicate across one or more wired or wireless networks (not shown). Network devices 112 may operate according to any suitable networking protocol and/or configuration to allow information to be transmitted by processing system 100 to a network or received by processing system 112 from a network.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A method performed by a processing system, the method comprising:
receiving a synchronization command that includes a filter tag as a parameter from a user device of a user, and
providing only a first set of items for the user that include the filter tag to the user device in response to the synchronization command and the parameter.

2. The method of claim 1 further comprising:
preventing a second set of items for the user that do not include the filter tag from being provided to the user device in response to the synchronization command.

3. The method of claim 2 further comprising:
identifying the first set of items by comparing the filter tag to a third set of items for the user, the third set of items including the first and the second sets of emails.

4. The method of claim 1 further comprising:
receiving the synchronization command that includes the filter tag from a communications network.

5. The method of claim 1, wherein the user device is one of a mobile phone or a tablet computer system.

6. A processing system comprising:
a memory to store a set of instructions; and
a processor to execute the set of instructions to:
receive a filter tag input by a user;
initiate a synchronization operation with the filter tag; and
display a set of items received from an email server that include the filter tag.

7. The processing system claim 6 wherein the processor is to execute the set of instructions to display a user interface that allows the user to enter the filter tag.

8. The processing system claim 6 wherein the processor is to execute the set of instructions to initiate the synchronization operation with the email subject by providing a synchronization command that includes the filter tag as a parameter to an email server.

9. The processing system claim 8 wherein the processor is to execute the set of instructions to initiate the synchronization operation with the filter tag by providing the synchronization command that includes the filter tag as the parameter to the email server using a communications network.

10. The processing system claim 6 wherein the processing system is one of a mobile phone or a tablet computer system.

11. A computer readable storage medium storing instructions that, when executed by a processing system, perform a method comprising:
displaying a user interface that allows a user to enter an email subject for a synchronization operation; and
providing a synchronization command that includes the email subject as a parameter to an email server.

12. The computer readable storage medium of claim 11, the method further comprising:
displaying at least one email received from the email server in response to the synchronization command, the email including the email subject.

13. The computer readable storage medium of claim 11, the method further comprising:
receiving the email subject entered by the user using the user interface;

14. The computer readable storage medium of claim 11, the method further comprising:
providing the synchronization command that includes the email subject as the parameter to the email server using a communications network.

15. The computer readable storage medium of claim 11, wherein the processing system is one of a mobile phone or a tablet computer system.
